(19) United States
(12) Patent Application Publication
(10) Pub. No.: US 2017/0330292 A1
(43) Pub. Date: Nov. 16, 2017

(54) CORRELATOR

(71) Applicant: ADOBE SYSTEMS INCORPORATED, San Jose, CA (US)

(72) Inventor: Jonathan LANCAR, Fremont, CA (US)

(21) Appl. No.: 15/156,144

(22) Filed: May 16, 2016

(51) Int. Cl. G06Q 50/00; G06Q 30/02

(52) U.S. Cl. CPC G06Q 50/01; G06Q 30/0269

(57) ABSTRACT

Systems and methods are disclosed herein for distributing online ads based on an automatically detected social media trend. The systems and methods involve detecting a social media trend based on a spike in user engagement with social media distributed via the Internet. The spike is detected based on amount of social media postings or interactions relating to a topic occurring within a time frame. The systems and methods associate a keyword with the social media trend by automatically analyzing content of the social media relating to the topic during the time frame of the spike and identify content for online ads to be distributed based on the keyword associated with the spike.

### TECHNICAL FIELD

This disclosure relates generally to computer-implemented methods and systems and more particularly relates to improving the efficiency and effectiveness of computing systems used to create, manage, and/or distribute online ads.

### BACKGROUND

Computer users execute content viewing applications, web browsers, search engines, social media applications, and other television and computer tools to access electronic content through electronic networks, i.e., online. Such content is often provided along with promotional materials. In one example, a visitor is presented with a promotion for a retail item when the visitor accesses a particular webpage or initiates a search engine search using a particular keyword. Many providers of promotional materials and other online content struggle to create and publish relevant content at a desired frequency, e.g., hourly, twice daily, every other day, etc., because it is often time consuming and difficult to identify or create appropriate content. For example, a marketer of a professional sports league may desire to publish numerous updates to its own website and post many social media posts per day and find it difficult to identify or create relevant materials for these many publications. Content ideation is difficult task that existing software systems do not adequately facilitate. In addition, while social trends are sometimes tracked, social trend information is disconnected from brand marketing. As a result, marketers are often unable to tailor marketing efforts using social trend information and thus miss opportunities to target their audiences with relevant, attention-grabbing, or otherwise well-suited online ads.

### SUMMARY

Systems and methods are disclosed herein for distributing online ads based on an automatically detected social media trend. The systems and methods involve detecting a social media trend based on a spike in user engagement in social media distributed via the Internet. In one example, the spike is detected based on determining that the amount of social media postings relating to a topic occurring within a time frame exceeds a predetermined threshold. The systems and methods associate a keyword with the social media trend by automatically analyzing content of the social media relating to the topic during the time frame of the spike and identify content for online ads to be distributed based on the keyword associated with the spike in user engagement.

Another embodiment of the invention involves systems and methods for distributing online ads that include social trend source content based on automatically detected sources of social media trends. The systems and methods involve detecting a social media trend based on a spike in user engagement with social media distributed via the Internet. Source content of the social media trend, such as a particular television program or event that inspired the spike in social media posts on the topic, is detected and determined to be a source of the social media trend. The systems and methods distribute online ads based on the identified source of the social media trend. For example, when a social media trend is inspired by a live broadcast on a television channel, that live program is identified as the source of the social media trend, an online video clip is generated based in part on the source, and provided on the television channel and/or the relevant social media platforms while the live broadcast of the source is still relevant, e.g., during a later commercial break during the live broadcast of the televisions program.

These illustrative features are mentioned not to limit or define the disclosure, but to provide examples to aid understanding thereof. Additional embodiments are discussed in the Detailed Description, and further description is provided there.

### BRIEF DESCRIPTION OF THE FIGURES

These and other features, embodiments, and advantages of the present disclosure are better understood when the following Detailed Description is read with reference to the accompanying drawings.

FIG. 1 illustrates an exemplary computer network environment in which an exemplary system automatically correlates social media trends with appropriate ad content and uses social media trend source information to distribute online ads.

FIG. 2 illustrates a flow chart illustrating an exemplary process in which online ad content relevant to a social media trend is identified and distributed.

FIG. 3 illustrates an example of using a social media feed to automatically publish appropriate online ads.

FIG. 4 is a flow chart illustrating an exemplary method for distributing online ads based on an automatically detected social media trend.

FIG. 5 is a flow chart illustrating an exemplary method for distributing online ads with social trend source content based on automatically detected sources of social media trends.

FIG. 6 is a block diagram depicting an example hardware implementation.

### DETAILED DESCRIPTION

As described above, existing systems support marketing efforts to distribute online ads but do not facilitate providing online ads relevant to social media trends. One embodiment of the invention distributes online ads based on automatically detecting social media trends and correlating appropriate online ad content. In one example, a social media trend is detected based on a spike in user engagement with social media, content of the social media is analyzed to associate a keyword with the social media trend, and content for online ads to be distributed is identified based on the keyword. The process provides online ads that are relevant to the social media trend while the social media trend is still relevant because it is automatic and because content for the online ads is readily correlated with the social media trend using the keyword-based lookup. Correlating appropriate content, for example, is facilitated using a media library for a marketer or brand with content and/or content portions that are already tagged with social media topics. Thus, when a social media spike occurs that is determined to be related to the keywords “marathon” and “heat,” an appropriate online ad is automatically selected. For example, the computer system can automatically identify a video clip for an online ad for a sports drink featuring last year's winner of a marathon commenting on how the drink helped her win the mid-summer marathon. In one implementation of the invention, an appropriate portion of a longer video clip is selected, for example, selecting only a fifteen-second long segment of a previously recorded one-minute long marathoner interview for the online ad based on that segment having tags for “marathon” and “heat” matching the keywords of the currently-identified social media trend.

Another embodiment of the invention distributes online ads based on automatically detecting social media trends, associating a likely source that caused or inspired the social media trend, and using the source to identify appropriate online ad content and/or identify an appropriate distribution channel for online ads. In one example, one or more social media distribution channels are monitored to identify a spike in discussion regarding a particular baseball player and a particular activity (e.g., hitting grand slams, having a wardrobe malfunction, recovering from an injury, etc.). The computer system uses keywords about the social media trend to identify a likely source of the trend, such as the broadcasting of that player's team's game currently on a particular television channel and via a particular web site or sites. Based on the current broadcast of a relevant event, e.g., the baseball game, the system identifies that the social media spike was caused or enhanced by that source.

This source information is useful in several ways to the provision of online ads. In one embodiment, the source of the social media trend is used to automatically and instantly generate an appropriate online ad. For example, as the live baseball game is broadcast, the game is also recorded and segments are tagged, for example, based on keywords from the words spoken by the TV announcers. An appropriate prior segment of the recorded baseball game is then automatically identified based on the tags (e.g., matching the social media trending topics) and used as an automatically created an online ad or suggestion for online ad content that a marketer can quickly, review, edit and/or publish.

The source information is additionally or alternatively useful to identify an appropriate distribution channel(s) for an online ad. For example, if a social media trend relates to the shoes that the baseball player is wearing and the source of the social media trend is identified as the baseball game that is currently being broadcast on a particular television channel, the system automatically identifies an online ad (e.g., based on the shoe topic trend) and appropriate distribution channels (e.g., the social media website and/or the television channel source of the social media trend).

In one example, a computer system automatically constructs and identifies a distribution channel for a shoe advertisement of a baseball player based on the shoe being discussed on social media during a source event. In this example, the online ad is created using an image of the player in the current game in which his shoe is visible and also using a previous recording of that player discussing the importance of his shoes to his performance. The online ad is then automatically published or quickly approved by a marketer and published on television channel while the baseball game is still playing live on that channel. In this example, the online ad is targeted based on social media to include content based on the social media trend, through a distribution channel that is likely being observed by the social media trend participants, and includes subject matter that is currently of interest to those participants. Online ads targeted using one or more of these features and/or other features may be more likely to increase return on investment for the marketer or otherwise selected to maximize performance criteria selected by the marketer.

As used herein, the phrase “online ad” refers to an advertisement, post, or other electronic content of any media type that promotes an idea, product, or service that is provided electronically in or with a web page, social media, keyword search result, e-mail, or other electronic communication sent, accessed by, or made available to one or more individuals through a computer network such as the Internet. Examples of online ads include, but are not limited to, images, text, graphics, sound, and/or video incorporated into a web page, search engine result, television content, or social media content on a social media app or web page that advertise or otherwise promote or sell something, usually a business's product or service.

As used herein, the phrase “electronic content” refers to any content in an electronic communication such as a web page or e-mail accessed by, or made available to, one or more individuals through a computer network such as the Internet. Examples of electronic content include, but are not limited to, images, text, graphics, sound, and/or video incorporated into a web page, search engine result, or social media content on a social media app or web page.

As used herein, the phrase “social media” refers to computer-mediated features that use the Internet or other electronic communications to allow people and/or companies to create, share, and exchange information, interests, and electronic content in virtual communities and social networks. Users of social media often, but not always, have profiles and/or accounts associated with friends or followers that receive or are notified of electronic content that is created, shared, or exchanged by the person(s) or company(ies) associated with the profile or account. In many, but not necessarily all, social media platforms one or more of the participants are able to respond to, repost, or otherwise follow up on a topic of another user's creation, sharing, or exchange of electronic content. Accordingly, social media platforms often, but not necessarily always, provide highly interactive platforms through which people and companies discuss topics and disseminate information about one or more topics. Some social media operate using dialogic transmission in which there are many sources of electronic content received by many others.

As used herein, the phrase “social media trend” refers to social media in a given time frame relating to a topic or social media changing to relate to a topic with more frequency or in greater intensity. For example, upon the death of a pop star there will often be a social media trend relating to the pop star in which, for a few days or more, social media users posting relating to that pop star are more common than before the pop star's death and/or posting related to the pop star are accessed by and interacted with more than previously.

As used herein, the phrase “user engagement” in social media refers to participation by users in creating, sharing, exchanging, viewing, and/or receiving information, interests, and other electronic content in virtual communities and social networks. A “spike” in user engagement refers to an increase in the amount of social media user postings or interactions relating to a topic occurring within a time frame. A spike in user engagement in social media for a particular topic is used as an indication of a social media trend in one embodiment.

As used herein, the phrase “keyword” refers to one or more words or phrases related to a topic. As users participate in social media they create, share, exchange, view, and receive electronic content in virtual communities and social networks. Such electronic content is often associated with one or more keywords. In one embodiment, electronic content items contain text, metadata, and/or tags that are used to identify keywords associated with the electronic content.

As used herein, the phrases “source” and “source content” refer to the inspiration or other cause for a social media trend topic. Source content is publishing separately from the social media during the time frame of the social media postings related to the topic and are determined to be an inspiration or cause of the social media trend.

As used herein, the phrases “campaign” and “marketing campaign” refer to a marketing effort comprising one or more online ads with a marketing objective such as increasing brand awareness for a particular brand. A campaign is associated with a “budget” that is to be spent over the duration of the campaign. A “budget” can be broken down into smaller increments, e.g., a daily budget, weekly budget, monthly budget, etc., for a given campaign. A “portfolio” includes one or more “campaigns.”

As used herein, the phrase “bid” refers to an offer to pay an amount for a search, webpage, or social media online ad opportunity in response to an online ad request. Bids are used to place online ads in display advertising, search advertising, and social media advertising. Bids are used as offers to pay to have an online ad provided by a search engine in search results that are provided in response to a search engine search in search advertising. Search advertising is often sold and delivered on the basis of search keywords. An individual uses a search engine to enter search keywords to make queries. A “search keyword” is one or more words or phrases. Several search engines conduct running auctions to sell online ads according to bids received for search keywords and relevance to online ads. In display advertising, an online ad (e.g., an image, text, audio, and/or video) is provided along with web page content in response to requests from one or more individuals for the web page. For example, a banner ad location on a web page that is populated to display an online ad is an example of a web page location. Another example is an opportunity to provide a pop-up ad along with requested web page content. Another example is an opportunity to play audio along with requested web page content. In social media advertising, an online ad (e.g., an image, text, audio, and/or video) is provided along with social media content. An example is a location in a news feed for an online ad. Another example is a location within a series of shared content items from a given user or account, e.g., a location with a series of tweets.

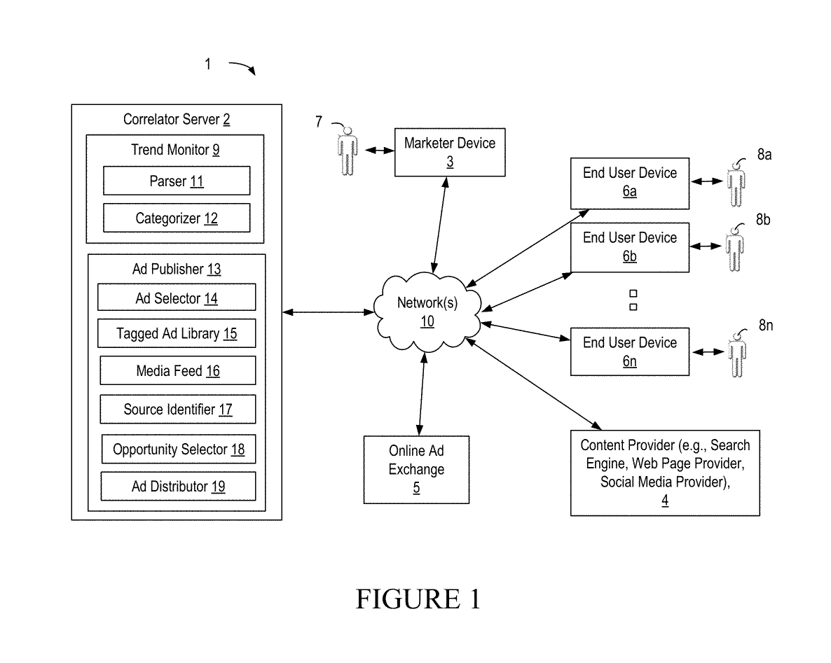

FIG. 1 illustrates an exemplary computer network environment 1 in which an exemplary system automatically correlates social media trends with appropriate ad content and uses social media trend source information to distribute online ads. The exemplary computer network environment 1 includes a correlator server 2, a marketer device 3, an exemplary content provider 4, an online ad exchange 5, and end user devices 6a-n. End user device 6a-n are used by visitors 8a-n to access electronic content via network 10 from content providers such as content provider 4. A marketer 7 implements a marketing campaign to distribute online ads along with the content that is obtained by the visitors 8a-n and viewed (or experienced) on end user devices 6a-n. For example, marketer 7 uses marketer device 2 to specify parameters of a marketing campaign that is ultimately used to determine how a marketing campaign budget will be used to pay for placement of the online ads with the electronic content obtained by the visitors 8a-n.

Correlator server 2 includes a trend monitor 9. The trend monitor 9 receives electronic content or information about electronic content from one or more social media platforms. For example, trend monitor 9 receives posts shared by users using one or more social media web sites to exchange comments with friends and followers. The trend monitor 9 uses the received electronic content information about electronic content from social media to identify that social media trends are occurring as they occur. In one example, the trend monitor 9 detects that a particular word or phrase is occurring with greater frequency in recent social media, e.g., in posts within the last hour or last 5 minutes, etc. In another example, trend monitor 9 detects that shared images are tagged with a particular word or phrase with greater frequency in recent image sharing occurrences. In another example, the trend monitor 9 detects that a link to a particular news article or posting exceeds a particular threshold number of links, e.g., more than 5000 postings have linked to a particular article within the last hour, etc.

The trend monitor 9, in this example, includes a parser 11 and categorizer 12 that are used analyze social media to identify one or more topics associated with a social media trend. In one example, parser 11 identifies words or phrases used in electronic content or information from electronic content from social media platforms and the categorizer 12 categorizes the electronic content or information about the electronic content into categories or topics. Based on one or more metrics, such as volume of posting, rate of posting, length of posting chain, etc., one or more topics are identified as trending by the trends monitor 9. In one example, the trend monitor 9 uses machine learning to categorize the most recent social media posts, etc., such as the latest Facebook® posts, latest Twitter® tweets, and/or latest Google® keyword searches, and/or any other social media streams that are relevant to such ends. In this example, the categorizer 12 summarizes the latest posts, etc. to identify keywords that represent the topics of social media trends.

The correlator server 2 also includes an ad publisher 13 that includes an ad selector 14, a tagged ad library 15, a source identifier 16, a media feed 17, an opportunity selector 18, and an ad distributor 19. The ad selector 13 uses the keywords identified for social media trends by the trend monitor 9 to identify appropriate online ads from the tagged ad library 15. For example, if the trend monitor 9 determines that the keyword “Greece” is currently trending as a social media topic, the ad selector 14 searches tagged ad library 15 for online ads, or particular portions of online ads, that are tagged with “Greece,” to identify appropriate online ads. In this way, the ad publisher is able to identify an online ad that is relevant to a social media trend while the trend is still relevant.

The media feed 16 includes a feed of online ads that are selected based on current social media trends. Such a feed can be produced by ad selector 14 selecting one online ad after another based on social media trends identified by trend monitor 9. Such a feed can be used by a marketer or marketing campaign to provide appropriate online ad content. For example, a marketing campaign implemented to post online ads at particular times of day (e.g., 8 am, noon, 4 pm, and 8 pm) can receive the feed and then publish on online ad from the feed for the relevant time of day. In this example, the media feed is specific to the marketing campaign. The online ads selected for the media feed 16 are thus both relevant to current social media trends and to the subject matter of the campaign. For example, the trend monitor 9 may identify many social media trends (e.g., World Cup, presidential debate, sun burn, Greece, no-hitter, etc.), the ad selector 14 may select online ads relevant to each of those keywords, and the media feed 16 may only include online ads that are relevant to a particular marketing campaign (e.g., only online ads identified based on “World Cup” and “no hitter” for a sports-related campaign). In an alternative implementation, the media feed 16 includes online ads related to numerous topics and a marketer manually or through an automated process pulls online ads from the media feed 16 for the particular marketing campaign. In general, the media feed 16 provides a convenient and efficient mechanism for a marketing campaign to automatically produce numerous and/or frequent online ads that are relevant to social media trends and/or a marketing campaign.

In one embodiment, the media feed 16 provides a social trends media feed 16 that is a real-time based list of media (images, GIFs, videos, etc.) from a campaign's media library which can be used to publish to social media platforms and other appropriate online ad locations. The media feed 16 can itself include online ads that are tagged with the social media trend identifying information (e.g., keywords from the trend monitor 9) to facilitate use of the media feed by a marketing campaign. If specific parts of a video, GIF, or other online ad are tagged with relevant labels, the media feed 16 can include such information and/or segment the content to include only the particular segments or portions that are relevant.

The source identifier 17 identifies the source of a social media trend. In one example, the source identifier 16 uses the keyword(s) from trend monitor 9 for current social media trends to search news articles, television programs, and other content that is recently published for keywords that match the keyword(s). For example, if the social media keyword is “Greece,” the source identifier 17 may identify that a news article relating to the finding of a significant ancient Greek artifact published the same day and is referenced in some of the early social media posts, etc. Accordingly, the source of the social media trends is identified by references in the social media and/or searching of broadcasts and other current publications for matching topics. In another example in which the trend monitor 9 identifies a trend relating to keywords “Braves” and “no-hitter,” the source identifier 17 identifies that a live baseball game involving a “Braves” baseball team is currently being aired on one or more television channels and via one or more websites.

In one embodiment, the source identifier 17 further uses electronic content from the source to produce some or all of an online ad. For example, if the source of a social media trend is a “Braves” baseball game currently being aired on one or more television channels, the source identifier 17 can identify an appropriate clip from that program, such as a clip of a third strike being thrown. In one example, the source identifier 17 interacts with the ad selector 14 to select a set of potentially relevant clips and a marketer is able to quickly review, select, crop, and edit one or more of the selected clips into an online ad. For example, a marketer 7 on marketer device 3 uses a user interface provided via correlator server 2 to review, select, crop, and edit one or more clips from an automatically selected set of potentially useful online ads clips for use in an online ad. This semi-automatic process provides an example of an implementation in which the correlator server 2 greatly reduces the amount of effort required from a marketer to quickly create content for social media relevant online ads.

The ad publisher 13 also includes an opportunity selector 18 that identifies locations (i.e., advertising opportunities) at which one or more online ads will be bid for and/or placed. For example, the opportunity selector 18 can identify that a social media trend relating to a particular keyword was mainly concentrated on one or more particular social media platforms or within particular feeds/conversations within a particular social media platform. The opportunity selector 18 uses information to determine that online ads selected based on that topic should be focused on online ad opportunities for the platforms and/or within the same particular feeds/conversations. In another example, the opportunity selector 18 identifies an online ad opportunity based on the identified source of the social media trend. For example, based on the source identifier 17 using the social media trend keywords “Braves” and “no-hitter” to identify that a live baseball game involving a “Braves” baseball team is currently being aired on one or more television channels and via one or more websites, the opportunity selector selects those particular television channel(s) and website(s) for placement of online ads selected using those keywords.

The ad distributor 19 places online ads based on the online ad selections made by the ad selector 14, the sources identified by the source identifier 17, and the opportunities selected by the opportunity selector 18. The ad distributor 19, for example, can send one or more electronic messages to online ad exchange 5 to bid on or otherwise purchase online ad publication with electronic content provided by content provider 5.

The ad publisher 13, in this example, is run in either manual or automatic mode. The manual mode allows the marketer to pick media and create posts based on the social media trend information. The automatic mode automatically creates relevant headlines, posts, and other online ads and is particular appropriate in circumstances in which it is desirable to provide online ads quickly and/or frequently that are response to social media trends.

The correlator server 2 can be implemented on one or more computing devices and one or more geographic and/or network locations. The correlator server 2, in one embodiment, provides an automated process that associates a marketer (or brand)'s media library or media stream, such as a portion of tagged ad library 15 associated with a particular marketer or brand, with engagement spikes on social media to produce online ads, such as short videos, images, GIFs or other media.

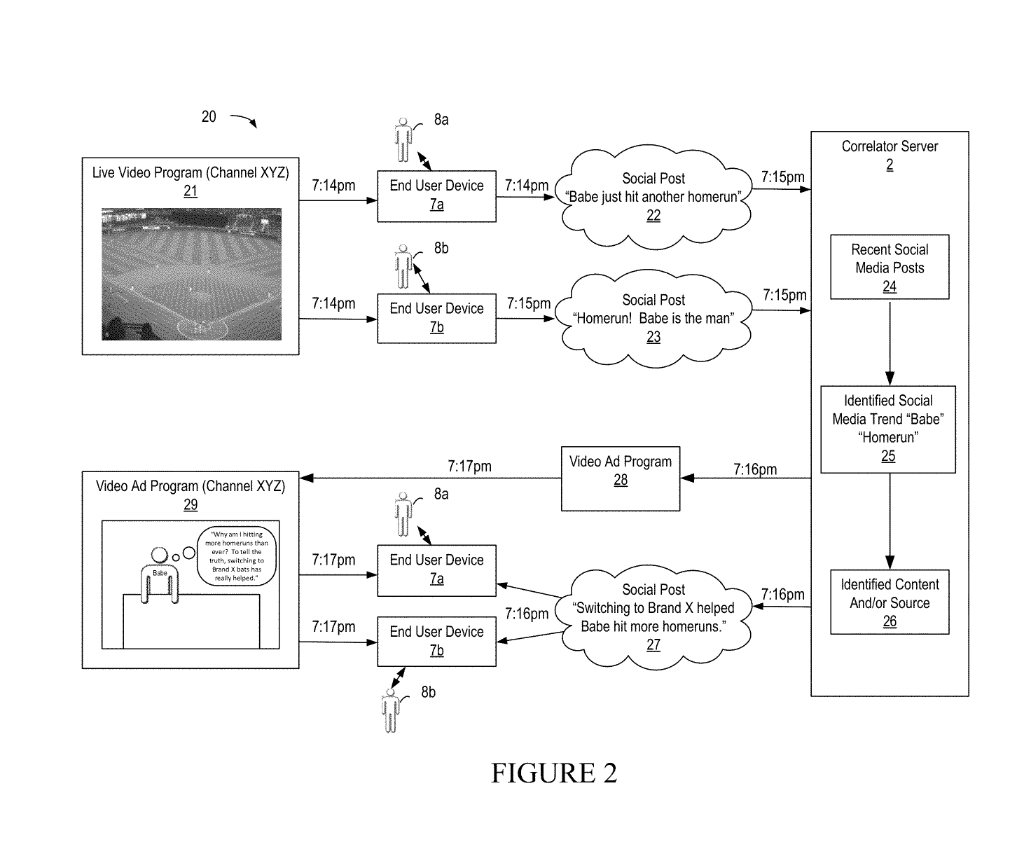

FIG. 2 illustrates a flow chart illustrating an exemplary process 20 in which online ad content relevant to a social media trend is identified and distributed. In this example, a live vide program 21 of a baseball game is broadcast on televisions channel XYZ. End user 8a receives and watches the broadcast using end user device 7a or another device in the end user 8a's location and end user 8b receives and watches the broadcast using end user device 7b or another device in the end user 8b's location. At 7:14 pm, the live video program 21 shows baseball hero “Babe X” hit his second homerun of the day with two men on base to give his team the lead in the baseball game. End user 8a uses end user device 7a to immediately publish a social media post 22 saying “Babe just hit another homerun.” Soon thereafter, at 7:15 pm, end user 8b uses end user device 7b to publish a social media post 23 saying “Homerun! Babe is the man.” These posts 22, 23 are distributed via the social media network or networks to respective friends and/or followers of the end users 8a, b.

The social media posts 22, 23 are also provided to correlator server 2. Correlator server 2 analyzes recent social media posts 23, including the social media posts 22, 23, to identify a social media trend 24 with keywords “Babe” and “homerun.” In this example, the social media trend and descriptive keywords are identified based on a spike in the frequency of occurrences of these keywords in social media posts during a particular timeframe and/or based on an increase in viewing or access to such postings. In one example, in the two minutes following the broadcast of the homerun, the system detects that over a threshold of 10,000 social media posts in a particular geographic area include these phrases. The correlator server 2 further identifies online ad content and/or sources 26 of the social media trend, e.g., identifying one or more appropriate online ads and/or the broadcast of the baseball game on channel XYZ as a likely source of the social media trend. In this example, online ads for a Brand X marketing campaign are automatically generated and/or selected.

The correlator server then publishes two online ads at 7:16 pm. A video online ad 28 composed or selected based on the keywords “Babe” and “homerun” is sent to the television broadcaster of channel XYZ to be included in the next television commercial on that channel. This video online ad 28 airs as video ad program 29 on channel XYZ at 7:17 pm and includes a portion of a prior player interview in which Babe says “Why am I hitting more homeruns than ever? To tell the truth, switching to Brand X bats has really helped.” The video ad program 29 then switches to a video clip from the current game's broadcast of babe hitting his first and second homeruns and then ends with a stock image of Brand X baseball bats. The video ad program is broadcast on the channel and thus received by end user devices 7a and 7b that are still tuned to that channel, as well as to numerous other users.

In this example the video ad program 28 that aired as video ad program 29 was composed based on social media trend keywords using content that was the source of the trend (i.e., the footage of the current game), as well as prior footage (i.e., the interview and the stock images) that were also selected based on the keywords. Moreover, the advertising opportunity (advertising on channel XYZ) was further identified based on the identified social media trend since the keywords of the trend where used to identify that channel's broadcast of the game as the source of the social media trend and thus that channel as an appropriate online ad opportunity for an online ad composed or selected based on that trend.

The correlator server 2 also publishes a social media post at 7:16 pm that is selected based on the social media trend, stating “Switching to Brand X helped Babe hit more homeruns.” In this example, the social media posting was selected to correspond and build off of the video ad program 28 and both online ads 27, 28 are published via communication channels to be received by a relevant audience of consumers such as end users 8a, 8b. In this way, the correlator 2 helps a marketer target relevant consumer with targeted content that is relevant to social media trends that are currently on the minds of those consumers and ultimately improve the efficiency and success of the marketing efforts.

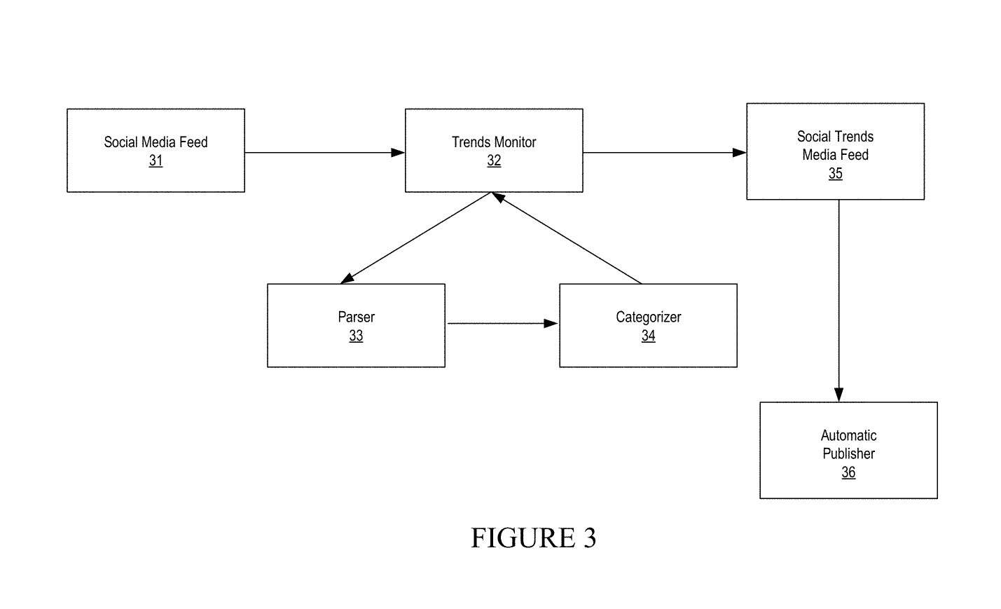

FIG. 3 illustrates an example of using a social media feed to automatically publish appropriate online ads. In this example social media feed 31 is received by trend monitor 32. Trend monitor 32 uses parser 33 to parse the social media feed to identify occurrences and frequencies of particular words and phrases and uses categorizer 34 to categorize particular trends in the social media feed 31 using keywords. The trends monitor 35 then produces a social trends media feed 35 based on the identified keywords. The automatic publisher 36 uses the social trends media feed 35 to publish online ads automatically or semi-automatically (e.g., based on marketer approval of automatically selected online ads).

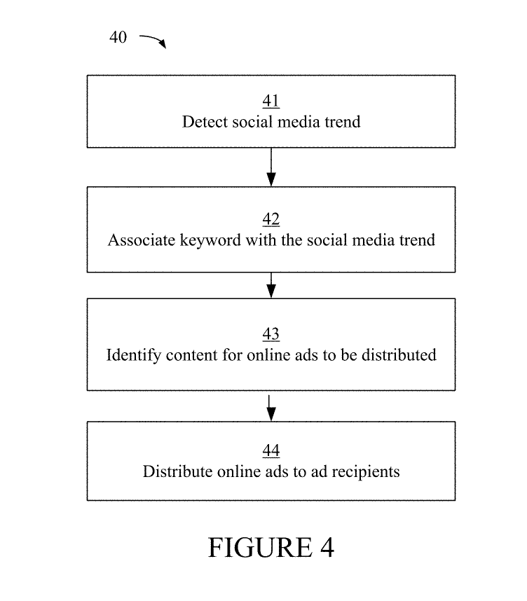

FIG. 4 is a flow chart illustrating an exemplary method 40 for distributing online ads based on an automatically detected social media trend. Exemplary method 40 is performed by one or more processors of one or more computing devices such as correlator server 2 of FIG. 1.

Exemplary method 40 involves detecting a social media trend, as shown in block 41. In one embodiment of the invention, the social media trend is detected based on a spike in user engagement with social media distributed via the Internet. A spike in user engagement is detected based on determining that the amount of social media postings or interactions relating to a topic occurring within a time frame exceeds a predetermined threshold. The predetermined threshold can be determined based on a specific preset level (e.g., any amount of user engagement over 10,000 posts is a spike) or based on a level that varies, e.g., a predetermined level that is based on a percentage above an average amount of user engagement (e.g., a spike occurs when the amount of user engagement is 50% more than normal, etc.). The predetermined threshold can also be based on amount of user engagement relating to the particular topic versus all topics (e.g., a spike occurs when 5% or more of posts relate to a particular topic, etc.)

The method 40 further involves associating a keyword with the social media trend, as shown in block 42. In one embodiment of the invention, associating a keyword with the social media trend involves automatically analyzing content of the social media relating to the topic during the time frame of the spike.

The method 40 further involves identifying content for online ads to be distributed, as shown in block 43. In one embodiment of the invention, the content is identified based on the keyword associated with the spike in user engagement that is used to identify the social media trend. The content is identified from a content library of preexisting content with tags correlated with social media engagement keywords, for example, content having a tag corresponding to the keyword associated with the social media trend. Portions or parts of content are identified in one embodiment of the invention. This involves, for example, selecting a portion of an image or time segment of a video from a content library based on a tag specific to the portion of the image or time segment of the video relating to the keyword associated with the social media trend.

Content for an online ad is identified based on a source of the social media trend in one implementation of the invention. The source is identified as content that publishes during the same time frame and that is determined to be a cause of the social media trend. In one example, the source is a sporting event being broadcast or distributed over a network at or around the time frame of a social media trend that has keywords related to the sporting event. In another example, the source is an individual portrayed in content that was broadcast or distributed over a network at or around the time frame of a social media trend that has keywords related to the individual. In another example, the source is an action or achievement being performed by an individual in content broadcast or distributed over a network that has keywords related to the sporting event.

The method 40 further involves distributing online ads to ad recipients, as shown in block 44. In one embodiment of the invention, distributing online ads involves directly posting social media posts, webpage updates, and/or sending targeting e-mails and other electronic messages. In another embodiment of the invention, distributing online ads involves determining or adjusting a search keyword bidding strategy based on the keyword associated with the social media trend. In one example, a search keyword bidding strategy is adjusted by determining to bid a larger value for a search keyword related to the keyword associated with the social media trend.

In one embodiment, the online ads are distributed while the social media trend is still relevant. For example, the online ads are distributed while the spike in user engagement related to the social media trend continues, e.g., while posting related to the trend continue to have significant volume or while a chain of postings continues to be accessed and/or added to. In another example, the social media trend is still relevant because the source of the social media trend continues to broadcast. For example, a social media trend related to a baseball player hitting a homerun is still relevant during the duration of the baseball game broadcast and/or while social media posts relating to the homerun and/or game continue to spike. Accordingly, determining that the social media trend is still relevant involves monitoring social media following the time frame of the initial social media trend determination.

The method 40, in one embodiment of the invention, further involves creating a media feed for a brand marketer with brand-targeted content items that corresponds to social media trends detected based on spikes in user engagement with topics in social media. The brand-targeted content is automatically identified from the feed to be provided in the online ads distributed by the brand to potential customers via the Internet.

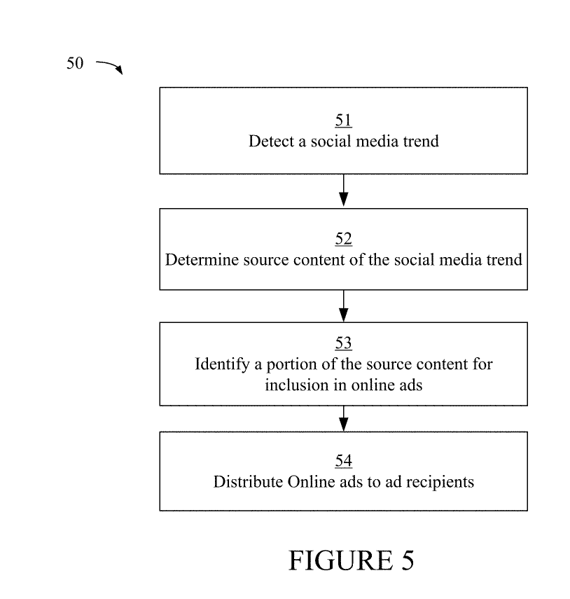

FIG. 5 is a flow chart illustrating an exemplary method 50 for distributing online ads with social trend source content based on automatically detected sources of social media trends. Exemplary method 50 is performed by one or more processors of one or more computing devices such as correlator server 2 of FIG. 1. The method 50 involves detecting a social media trend, as shown in block 51. In one embodiment of the invention, the social media trend is detected based on a spike in user engagement with social media distributed via the Internet. A spike in user engagement is detected based on determining that the amount of social media postings or interactions relating to a topic occurring within a time frame exceeds a predetermined threshold. The method 50 further involves determining source content of the social media trend, as shown in block 52. The source content is content publishing separately from the social media during the time frame related to the topic and determined to be a source of the social media trend.

The method 50 further involves identifying a portion of the source content for inclusion in online ads, as shown in block 53. The portion of the source content is identified based on the portion relating to the social media trend. For example, a portion of a presidential candidate debate containing particular keywords relevant to a social media trend is automatically identified based on those keywords. For example, a flurry of social media postings inspired by a presidential candidate stating that “I am not a crook” during a live broadcast is identified and used to select a clip from the live broadcast of that comment and automatically create a commercial using that clip. Such content, in one embodiment of the invention, is combined with existing content, e.g., stock images, videos, and other online ad content to compose an online ad. The existing content can also be selected based on the determined source content. In the “I am not a crook” example in which the presidential debate is identified as the source content, the existing content might be a previously recorded interview with the presidential candidate relating to honesty and an online ad relating to deodorant keeping the wearer dry when under pressure.

The method 50 further involves distributing the online ads to ad recipients, as shown in block 54. For example, the online ads are distributed to the social media users participating in the social media trend and/or to ad recipients receiving a broadcast that included the source content. The online ads are preferably, but not necessarily, distributed while the trend is still relevant as determined by further monitoring of social media following the time frame of the social media trend.

### Exemplary Computing Environment

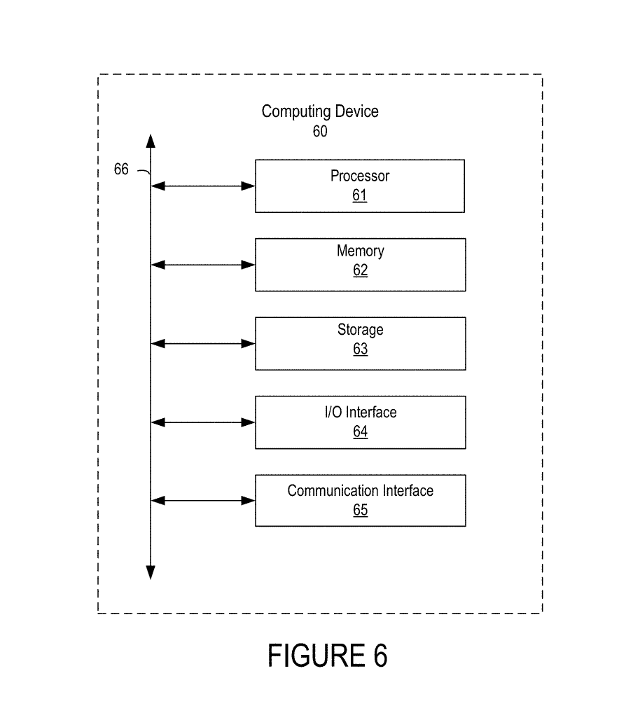

Any suitable computing system or group of computing systems can be used to implement the techniques and methods disclosed herein. For example, FIG. 6 is a block diagram depicting examples of implementations of such components. The computing device 60 can include a processor 61 that is communicatively coupled to a memory 62 and that executes computer-executable program code and/or accesses information stored in memory 62 or storage 63. The processor 61 may comprise a microprocessor, an application-specific integrated circuit (“ASIC”), a state machine, or other processing device. The processor 61 can include one processing device or more than one processing device. Such a processor can include or may be in communication with a computer-readable medium storing instructions that, when executed by the processor 61, cause the processor to perform the operations described herein.

The memory 62 and storage 63 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, memory chip, ROM, RAM, an ASIC, a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, Visual Basic, Java, Python, Perl, JavaScript, and ActionScript.

The computing device 60 may also comprise a number of external or internal devices such as input or output devices. For example, the computing device is shown with an input/output (“I/O”) interface 64 that can receive input from input devices or provide output to output devices. A communication interface 65 may also be included in the computing device 60 and can include any device or group of devices suitable for establishing a wired or wireless data connection to one or more data networks. Non-limiting examples of the communication interface 65 include an Ethernet network adapter, a modem, and/or the like. The computing device 60 can transmit messages as electronic or optical signals via the communication interface 65. A bus 66 can also be included to communicatively couple one or more components of the computing device 60.

The computing device 60 can execute program code that configures the processor 61 to perform one or more of the operations described above. The program code can include one or more modules. The program code may be resident in the memory 62, storage 63, or any suitable computer-readable medium and may be executed by the processor 61 or any other suitable processor. In some embodiments, modules can be resident in the memory 62. In additional or alternative embodiments, one or more modules can be resident in a memory that is accessible via a data network, such as a memory accessible to a cloud service.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure the claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

What is claimed is:

1. A method for distributing online ads based on an automatically detected social media trend, the method comprising:
detecting a social media trend based on a spike in user engagement with social media distributed via the Internet, wherein the spike is detected based on determining that an amount of social media postings or interactions relating to a topic occurring within a time frame exceeds a predetermined threshold;
associating a keyword with the social media trend by automatically analyzing content of the social media relating to the topic during the time frame of the spike; and
identifying content for online ads to be distributed, the content identified based on the keyword associated with the spike.

2. The method of claim 1, wherein the content is identified from a content library of preexisting content with tags correlated with social media engagement keywords, wherein the content has a tag corresponding to the keyword associated with the social media trend.

3. The method of claim 1, wherein identifying the content comprises selecting a portion of an image from a content library based on a tag specific to the portion of the image relating to the keyword associated with the social media trend.

4. The method of claim 1, wherein identifying the content comprises selecting a time segment of a video clip from a content library based on a tag specific to the time segment of the video clip relating to the keyword associated with the social media trend.

5. The method of claim 1, wherein the content is identified from a source, the source publishing during the time frame and determined to be a cause of the social media trend.

6. The method of claim 5, wherein the source is a sporting event being broadcast or distributed over a network at or around the time frame.

7. The method of claim 5, wherein the source is an individual portrayed in content that was broadcast or distributed over a network at or around the time frame.

8. The method of claim 5, wherein the source is an action or achievement being performed by an individual in content broadcast or distributed over a network.

9. The method of claim 1 further comprising distributing online ads while the social media trend is still relevant.

10. The method of claim 1 further comprising distributing online ads while the social media trend is still relevant, wherein the social media trend is determined to still be relevant by further monitoring social media following the time frame.

11. The method of claim 1 further comprising creating a media feed for a brand marketer with brand-targeted content items that corresponds to social media trends detected based on spikes in user engagement with topics in social media.

12. The method of claim 11, wherein the brand-targeted content is automatically identified from the feed to be provided in the online ads distributed by the brand to potential customers via the Internet.

13. The method of claim 11 further comprising determining or adjusting a search keyword bidding strategy based on the keyword associated with the social media trend.

14. The method of claim 13, wherein adjusting the search keyword bidding strategy comprises determining to bid a larger value for a search keyword related to the keyword associated with the social media trend.

15. A method for distributing online ads with social trend source content based on automatically detected sources of social media trends, the method comprising:
detecting a social media trend based on a spike in user engagement with social media distributed via the Internet, wherein the spike is detected based on determining that an amount of social media postings relating to a topic occurring within a time frame exceeds a predetermined threshold;
determining source content of the social media trend, wherein the source content is content publishing separately from the social media during the time frame related to the topic and determined to be a source of the social media trend; and
identifying a portion of the source content for inclusion in online ads to be distributed, the portion of the source content identified based on the portion of the source content relating to the social media trend.

16. The method of claim 15, wherein the online ads are distributed to the social media users participating in the social media trend.

17. The method of claim 15, wherein the online ads are distributed ad recipients receiving a broadcast that included the source content.

18. The method of claim 15, wherein the online ads further comprise previously created content identified based on the determined source content.

19. The method of claim 15, wherein the online ads are distributed while the trend is still relevant as determined by further monitoring of social media following the time frame.

20. A system comprising:
a processor;
instructions stored on a non-transitory medium, wherein, when executed by a processor, the instructions perform operations comprising:
detecting a social media trend based on a spike in user engagement with social media distributed via the Internet, wherein the spike is detected based on determining that an amount of social media postings or interactions relating to a topic occurring within a time frame exceeds a predetermined threshold;
associating a keyword with the social media trend by automatically analyzing content of the social media relating to the topic during the time frame of the spike; and
identifying content for online ads to be distributed, the content identified based on the keyword associated with the spike.
